(19) United States
(12) Patent Application Publication
(10) Pub. No.: US 2016/0356317 A1
(43) Pub. Date: Dec. 8, 2016

(54) CONSTANT-VELOCITY JOINT

(71) Applicant: JTEKT CORPORATION, Osaka-shi (JP)

(72) Inventors: Isashi KASHIWAGI, Kariya-shi (JP); Masahito IKEO, Kariya-shi (JP); Hideki SUGIURA, Nagakute-shi (JP)

(73) Assignee: JTEKT CORPORATION, Osaka-shi (JP)

(21) Appl. No.: 15/170,205

(22) Filed: Jun. 1, 2016

(30) Foreign Application Priority Data
Jun. 8, 2015 (JP) 2015-116016

(51) Int. Cl. F16D 3/2245

(52) U.S. Cl. CPC F16D 3/2245; F16D 2003/22309

(57) ABSTRACT

A constant-velocity joint includes: an outer joint member; an inner joint member that is placed in the outer joint member and that can be angled with respect to the outer joint member; and balls that roll between the outer joint member and the inner joint member to transmit torque. First outer larger diameter portions and second outer larger diameter portions are formed alternately in the circumferential direction in the inner peripheral surface of the outer joint member. The center of an arc radius of a track of the center of the ball rolling on the first outer larger diameter portion and the center of an arc radius of a track of the center of the ball rolling on the second outer larger diameter portion are located on different sides with respect to the joint center in the axial direction of the outer joint member.

### INCORPORATION BY REFERENCE

The disclosure of Japanese Patent Application No. 2015-116016 filed on Jun. 8, 2015 including the specification, drawings and abstract, is incorporated herein by reference in its entirety.

### BACKGROUND OF THE INVENTION

1. Field of the Invention

The present invention relates to constant-velocity (CV) joints for use in vehicles etc.

2. Description of the Related Art

Conventionally, ball-type CV joints are known which are formed by an outer joint member having the shape of a bottomed cylinder, an inner joint member attached to the tip end of a shaft and inserted in the outer joint member, and a plurality of balls each placed between a corresponding one of a plurality of outer ball grooves formed in the inner peripheral surface of the outer joint member and a corresponding one of a plurality of inner ball grooves formed in the outer peripheral surface of the inner joint member. In such ball-type CV joints, each ball rolls between the outer ball groove and the inner ball groove, so that torque can be transmitted between the outer joint member and the inner joint member with the inner joint member being angled with respect to the outer joint member.

Such a CV joint includes a cage that holds the plurality of balls to prevent the balls from coming off from the inner and outer ball grooves. A part of the CV joint where the balls are held between the outer and inner ball grooves is shaped to open toward the opening of the outer joint member.

Accordingly, when rolling between the outer and inner ball grooves, the balls are pressed by the outer and inner ball grooves and are thus subjected to a force toward the opening of the outer joint member. The balls therefore attempt to move toward the opening of the outer joint member. The cage is thus pressed by the balls toward the opening of the outer joint member, so that the cage attempts to move toward the opening of the outer joint member. As a result, the cage is pressed by the outer and inner joint members, and a frictional force is generated between the cage and the outer and inner joint members, causing mechanical loss.

In order to solve such a problem, a CV joint is proposed in which outer ball grooves and inner ball grooves have an S-shape in the axial direction, and the shapes in the axial direction of the outer and inner ball grooves adjacent to each other in the circumferential direction are reversed from each other, as described in Japanese Patent Application Publication No. 2012-7741 (JP 2012-7741 A). In the CV joint described in JP 2012-7741 A, since the shapes in the axial direction of the outer and inner ball grooves adjacent to each other in the circumferential direction are reversed from each other, axial forces that are applied to the balls can almost completely cancel each other out. This reduces an axial force that is applied from the balls to the cage, and thus reduces a frictional force between the cage and the outer and inner joint members, whereby mechanical loss is reduced.

In the CV joint described in JP 2012-7741 A, however, since the outer and inner ball grooves have an S-shape, it is difficult to form the outer and inner ball grooves without using a special machine tool, and it is also difficult to control quality of the outer and inner ball grooves. This increases manufacturing cost of the outer and inner joint members and thus increases cost of the CV joint.

### SUMMARY OF THE INVENTION

It is one object of the present invention to provide a CV joint that can reduce mechanical loss without increasing cost.

A CV joint according to one aspect of the present invention includes: an outer joint member that has an accommodating recess and that has first outer ball grooves and second outer ball grooves formed in its inner peripheral surface; an inner joint member that has first inner ball grooves and second inner ball grooves formed in its outer peripheral surface, that is placed in the accommodating recess, and that can be angled with respect to the outer joint member with a joint center serving as a rotation center; balls each rolls between corresponding one of the first outer ball grooves and corresponding one of the first inner ball grooves or between corresponding one of the second outer ball grooves and corresponding one of the second inner ball grooves to transmit torque; and a cage that is placed between the inner peripheral surface of the outer joint member and the outer peripheral surface of the inner joint member to hold the balls, wherein the first outer ball grooves each have a first outer larger diameter portion, a center of an arc radius of a track of a center of the ball rolling on the first outer larger diameter portion is located beyond an axis of the outer joint member in a radial direction of the outer joint member, as viewed from the first outer larger diameter portion, the center of the arc radius of the track of the center of the ball rolling on the first outer larger diameter portion is located closer to an inner side of the accommodating recess than the joint center is in an axial direction of the outer joint member, the second outer ball grooves each have a second outer larger diameter portion, a center of an arc radius of a track of the center of the ball rolling on the second outer larger diameter portion is located beyond the axis of the outer joint member in the radial direction of the outer joint member, as viewed from the second outer larger diameter portion, the center of the arc radius of the track of the center of the ball rolling on the second outer larger diameter portion is located closer to an opening side of the accommodating recess than the joint center is in the axial direction of the outer joint member, the first inner ball grooves each have a first inner larger diameter portion, a center of an arc radius of a track of the center of the ball rolling on the first inner larger diameter portion is located beyond an axis of the inner joint member in a radial direction of the inner joint member, as viewed from the first inner larger diameter portion, the center of the arc radius of the track of the center of the ball rolling on the first inner larger diameter portion is located closer to the opening side of the accommodating recess than the joint center is in an axial direction of the inner joint member, the second inner ball grooves each have a second inner larger diameter portion, a center of an arc radius of a track of the center of the ball rolling on the second inner larger diameter portion is located beyond the axis of the inner joint member in the radial direction of the inner joint member, as viewed from the second inner larger diameter portion, and the center of the arc radius of the track of the center of the ball rolling on the second inner larger diameter portion is located closer to the inner side of the accommodating recess than the joint center is in the axial direction of the inner joint member.

The center of the arc radius of the track of the center of the ball rolling on the first outer larger diameter portion and the center of the arc radius of the track of the center of the ball rolling on the second outer larger diameter portion are thus located on different sides with respect to the joint center in the axial direction of the outer joint member. The center of the arc radius of the track of the center of the ball rolling on the first inner larger diameter portion and the center of the arc radius of the track of the center of the ball rolling on the second inner larger diameter portion are also located on different sides with respect to the joint center in the axial direction of the inner joint member. Moving forces that are applied to the balls adjacent to each other thus cancel each other out. Each ball held between the first outer larger diameter portion and the first inner larger diameter portion and rolling therebetween is subjected to a first moving force toward the inner side of the accommodating recess, and each ball held between the second outer larger diameter portion and the second inner larger diameter portion and rolling therebetween is subjected to a second moving force toward the opening side of the accommodating recess. Since the first moving force and the second moving force thus act in the opposite directions, these forces cancel each other out, which reduces an axial moving force that is applied to the cage in contact with the balls. This reduces a frictional force that is generated between the cage and the outer and inner joint members as the cage is pressed by the outer joint member and the inner joint member, whereby mechanical loss of the CV joint is reduced.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is an axial sectional view of a CV joint;

FIG. 2 is a diagram as viewed in the direction of arrow II in FIG. 1, showing an outer joint member as viewed from its opening;

FIG. 3 is a sectional view of a first outer ball groove, taken along line in FIG. 2;

FIG. 4A is a sectional view of an outer tapered portion, taken along line IVa-IVa in FIG. 3;

FIG. 4B is a sectional view of the outer tapered portion, taken along line IVb-IVb in FIG. 3;

FIG. 5 is a sectional view of a second outer ball groove, taken along line V-V in FIG. 2;

FIG. 6 is a diagram as viewed in the direction of arrow VI in FIG. 1, showing an inner joint member as viewed from the opening of the outer joint member;

FIG. 7 is a sectional view of a first inner ball groove, taken along line VII-VII in FIG. 6;

FIG. 8 is a sectional view of a second inner ball groove, taken along line VIII-VIII in FIG. 6; and

FIG. 9 is a detailed axial sectional view of the CV joint with a ball being in contact with the outer tapered portion or with the ball having come off from the outer tapered portion.

### DETAILED DESCRIPTION OF EMBODIMENTS

The structure of a constant-velocity (CV) joint 100 of an embodiment will be described with reference to FIG. 1. The lateral direction in the plane of paper of FIG. 1 is the axial direction of the CV joint 100 and each member of the CV joint 100. The CV joint 100 is disposed between a motor such as an engine of a vehicle and a driving wheel of the vehicle to transmit torque between the motor and the driving wheel.

As shown in FIG. 1, the CV joint 100 has an outer joint member 10, a shaft 20, an inner joint member 30, balls 40, and a cage 50. The CV joint 100 of the present embodiment is a ball-type CV joint having the balls 40 that roll between the outer joint member 10 and the inner joint member 30 to transmit torque. The CV joint 100 includes both a fixed CV joint in which the shaft 20 does not move in the axial direction, and a double offset CV joint in which the shaft 20 moves in the axial direction.

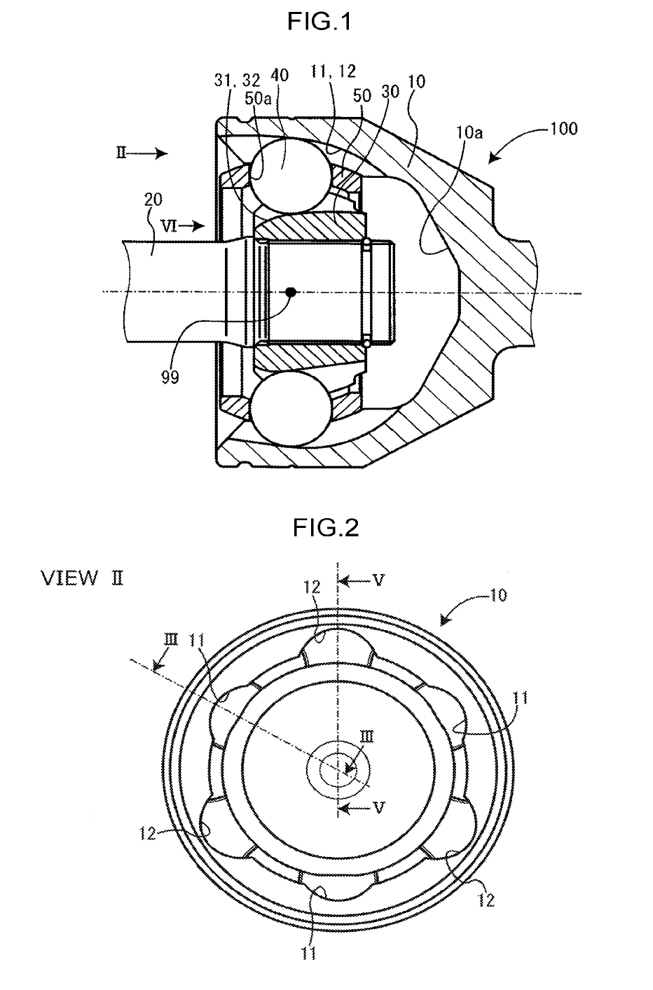

The outer joint member 10 has the shape of a bottomed cylinder (the shape of a cup) and has an accommodating recess 10a. The outer joint member 10 is coupled to a first torque transmission member that transmits torque. First outer ball grooves 11 and second outer ball grooves 12 are formed alternately in the circumferential direction of the outer joint member 10 in the inner peripheral surface of the accommodating recess 10a of the outer joint member 10 (FIG. 2). In the present embodiment, the outer joint member 10 has three first outer ball grooves 11 and three second outer ball grooves 12. That is, the number of first outer ball grooves 11 is the same as that of second outer ball grooves 12. The shaft 20 is coupled to a second torque transmission member that transmits torque. The shaft 20 has its tip end inserted in the outer joint member 10.

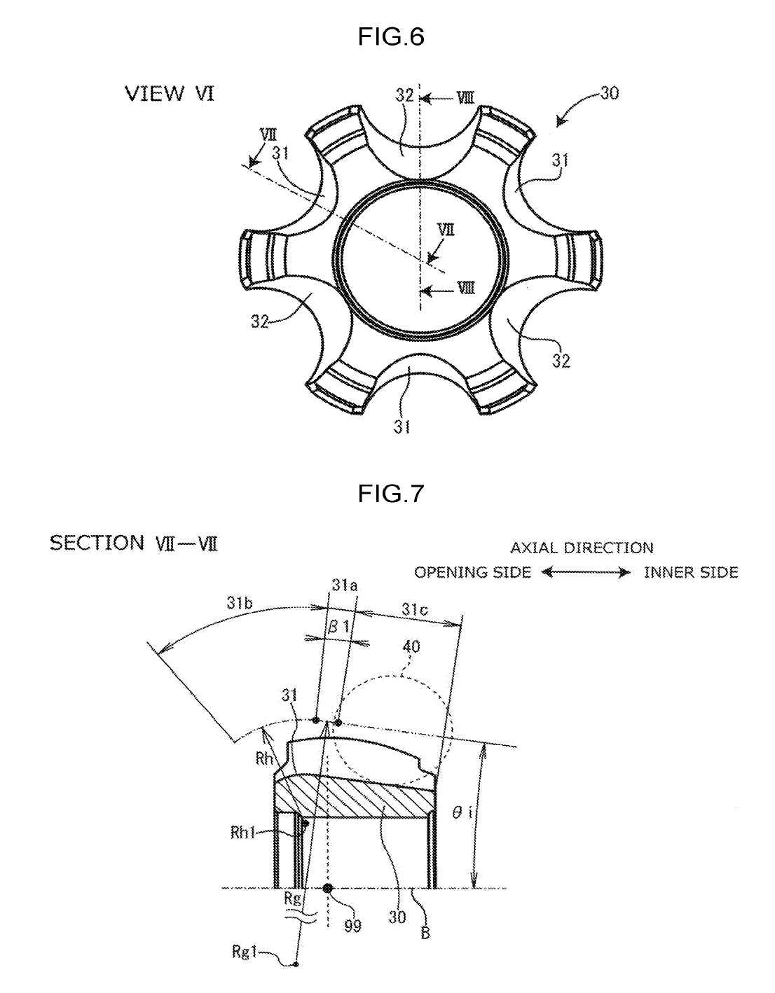

The inner joint member 30 is attached to the outer peripheral surface of the tip end of the shaft 20 so as not to be rotatable relative to the shaft 20, and is placed in the accommodating recess 10a of the outer joint member 10. First inner ball grooves 31 and second inner ball grooves 32 are formed alternately in the circumferential direction of the inner joint member 30 in the outer peripheral surface of the inner joint member 30 (FIG. 6). In the present embodiment, the inner joint member 30 has three first inner ball grooves 31 and three second inner ball grooves 32. The first outer ball grooves 11 face the first inner ball grooves 31, and the second outer ball grooves 12 face the second inner ball grooves 32.

Each of the balls 40 is placed between a corresponding one of the outer ball grooves 11, 12 and a corresponding one of the inner ball grooves 31, 32 which face each other. This configuration allows the inner joint member 30 to be angled with respect to the outer joint member 10 with a joint center 99 serving as a rotation center. In other words, the outer joint member 10 rotates about the joint center 99 relative to the shaft 20 and the inner joint member 30. The joint center 99 thus serves as the center of relative rotation between the outer joint member 10 and the inner joint member 30. As shown in FIG. 1, the joint center 99 is located on the axis of the outer joint member 10 and the inner joint member 30.

Each of the balls 40 rolls between the outer ball groove 11, 12 and the inner ball groove 31, 32 to transmit torque between the outer joint member 10 and the inner joint member 30. Torque can thus be transmitted between the outer joint member 10 and the inner joint member 30 (shaft 20) with the axial direction of the outer joint member 10 being angled with respect to the axial direction of the inner joint member 30 (shaft 20).

The cage 50 is placed between the inner peripheral surface of the outer joint member 10 and the outer peripheral surface of the inner joint member 30. The cage 50 has accommodating holes 50a formed at fixed angles, and holds the plurality of balls 40 in the accommodating holes 50a.

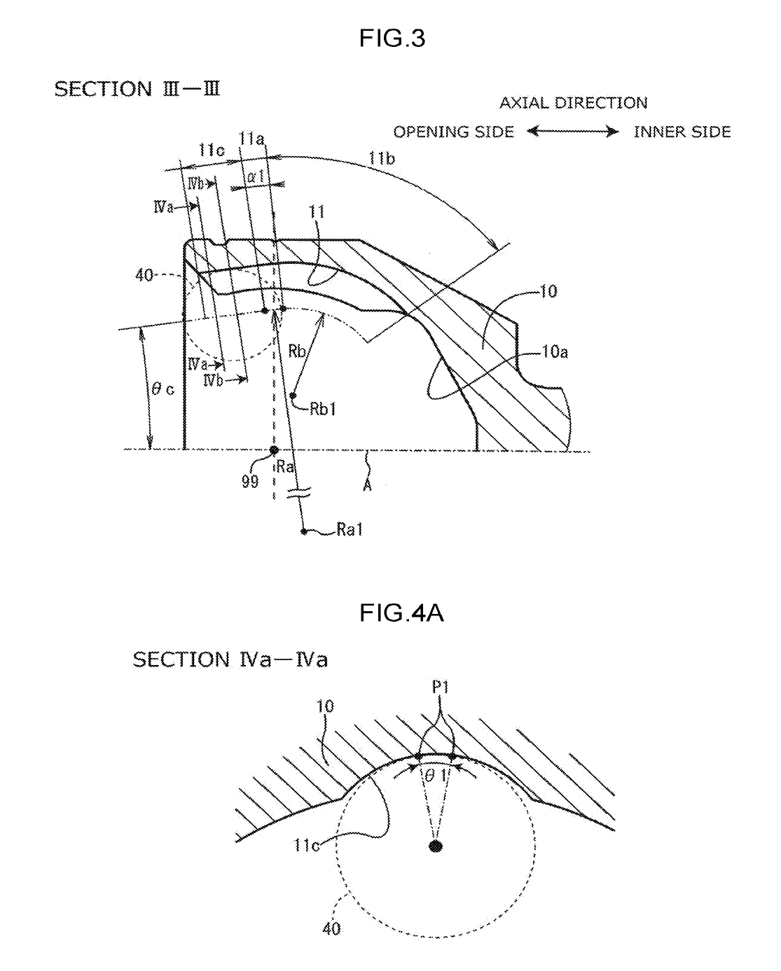

The first outer ball groove 11 will be described below with reference to FIG. 3. In FIG. 3, an alternate long and short dashed line A represents the axis (rotation center) of the outer joint member 10, and a long dashed double-short dashed line represents the track of the center of the ball 40 rolling in the first outer ball groove 11. As shown in FIG. 3, the first outer ball groove 11 is formed by an outer tapered portion 11c, a first outer larger diameter portion 11a, and a first outer smaller diameter portion 11b which are continuously formed in this order from the opening side toward the inner side (bottom side) of the accommodating recess 10a.

The first outer larger diameter portion 11a has an arc-shaped section in the axial direction. The center Ra1 of an arc radius Ra of the track of the center of the ball 40 rolling on the first outer larger diameter portion 11a is located closer to the inner side (bottom side) of the accommodating recess 10a than the joint center 99 is in the axial direction of the outer joint member 10. The inside diameter of the first outer larger diameter portion 11a thus gradually decreases toward the opening side of the accommodating recess 10a. The center Ra1 of the arc radius Ra of the track of the center of the ball 40 rolling on the first outer larger diameter portion 11a is located beyond the axis of the outer joint member 10 in the radial direction of the outer joint member 10, as viewed from the first outer larger diameter portion 11a.

The angle α1 formed by the first outer larger diameter portion 11a in the axial direction of the outer joint member 10 is an viewed angle for a track of the center of the ball 40, the track created by the ball 40 rolling on the first outer larger diameter portion 11a in the case where the outer joint member 10 is connected to a steered wheel and the angle formed by the axis of the inner joint member 30 (shaft 20) and the axis of the outer joint member 10 is a normal angle. As used herein, the term “normal angle” refers to the range of angles that are formed by the axis of the inner joint member 30 and the axis of the outer joint member 10 (hereinafter simply referred to as the “joint angles”) in view of the suspension stroke when the vehicle is traveling straight. It is preferable that the angle α1 be 8° or less. If the angle α1 is larger than 8°, the accommodating recess 10a has a smaller opening, and the shaft 20 may contact the opening of the accommodating recess 10a of the outer joint member 10, depending on the shape of the outer joint member 10, etc. It is also preferable that the angle α1 be 6° or more. If the angle α1 is smaller than 6°, the ball 40 rolls in the first outer ball groove 11 other than the first outer larger diameter portion 11a if the joint angle changes due to the suspension stroke when the vehicle is traveling straight. The angle α1 is therefore 6° to 8°. In the present embodiment, the angle α1 is 7°.

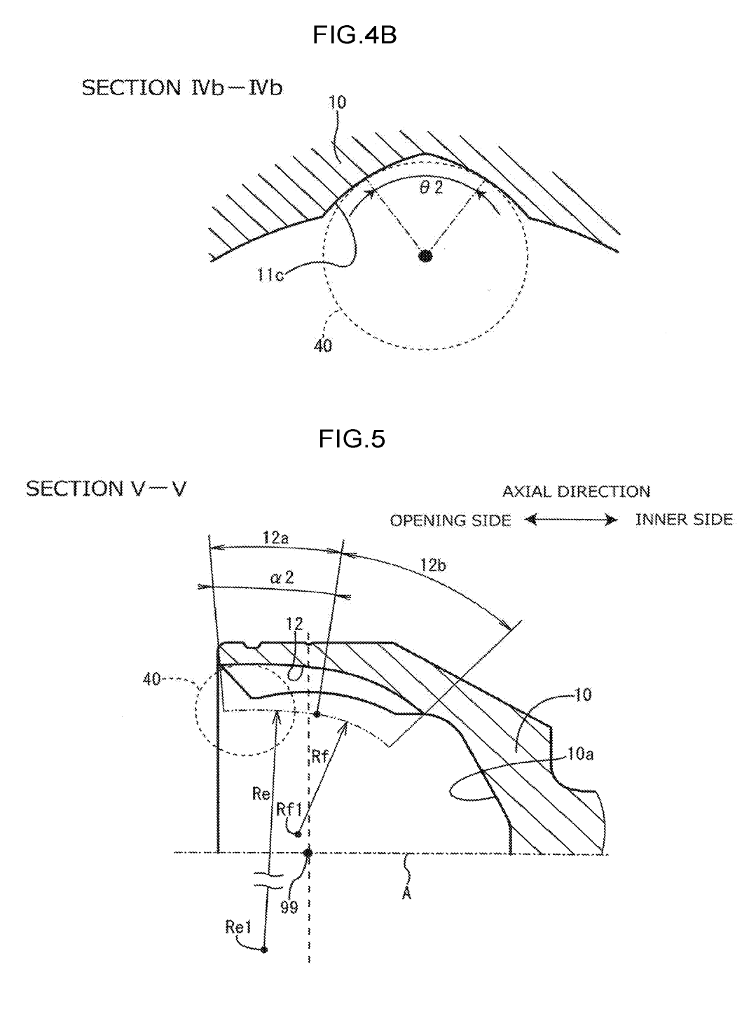

The outer tapered portion 11c is formed closer to the opening side of the accommodating recess 10a than the first outer larger diameter portion 11a is in the first outer ball groove 11. The outer tapered portion 11c has such a tapered shape that its inside diameter gradually decreases closer to the opening side of the accommodating recess 10a. In the present embodiment, the angle θc formed by the outer tapered portion 11c and the axis of the outer joint member 10 in the axial direction of the outer tapered portion 11c is constant. As shown in FIGS. 3, 4A, and 4B, the contact angle θ between the outer tapered portion 11c and the ball 40 in a section of the outer tapered portion 11c in a direction perpendicular to the track of the center of the ball 40 (a section in the radial direction of the outer joint member 10) gradually decreases from the inner side toward the opening side of the accommodating recess 10a.

The first outer smaller diameter portion 11b is formed closer to the inner side (bottom side) of the accommodating recess 10a than the first outer larger diameter portion 11a is in the first outer ball groove 11. The first outer smaller diameter portion 11b has an arc-shaped section in the axial direction. An arc radius Rb of the track of the center of the ball 40 rolling on the first outer smaller diameter portion 11b is smaller than the arc radius Ra of the track of the center of the ball 40 rolling on the first outer larger diameter portion 11a. The arc radius Ra is 1.1 to 7 times the arc radius Rb. The center Rb1 of the arc radius Rb of the track of the center of the ball 40 rolling on the first outer smaller diameter portion 11b is located closer to the inner side (bottom side) of the accommodating recess 10a than the joint center 99 is in the axial direction of the outer joint member 10. The center Rb1 of the arc radius Rb of the track of the center of the ball 40 rolling on the first outer smaller diameter portion 11b is located closer to the first outer smaller diameter portion 11b than the axis of the outer joint member 10 is in the radial direction of the outer joint member 10 (that is, the center Rb1 is located on the same side of the axis of the outer joint member 10 as the first outer smaller diameter portion 11b). The inside diameter of the first outer smaller diameter portion 11b gradually decreases closer to the inner side (bottom side) of the accommodating recess 10a.

The second outer ball groove 12 will be described below with reference to FIG. 5. In FIG. 5, an alternate long and short dashed line A represents the axis of the outer joint member 10, and a long dashed double-short dashed line represents the track of the center of the ball 40 rolling in the second outer ball groove 12. As shown in FIG. 5, the second outer ball groove 12 is formed by a second outer larger diameter portion 12a and a second outer smaller diameter portion 12b which are continuously formed in this order from the opening side toward the inner side (bottom side) of the accommodating recess 10a.

The second outer larger diameter portion 12a has an arc-shaped section. The center Re1 of an arc radius Re of the track of the center of the ball 40 rolling on the second outer larger diameter portion 12a is located closer to the opening side of the accommodating recess 10a than the joint center 99 is in the axial direction of the outer joint member 10. The inside diameter of a part of the second outer larger diameter portion 12a which is located near its connection portion with the second outer smaller diameter portion 12b thus gradually increases toward the opening side of the accommodating recess 10a. The center Re1 of the arc radius Re of the track of the center of the ball 40 rolling on the second outer larger diameter portion 12a is located beyond the axis of the outer joint member 10 in the radial direction of the outer joint member 10, as viewed from the second outer larger diameter portion 12a (that is, the center Re1 is located on the opposite side of the axis of the outer joint member 10 from the second outer larger diameter portion 12a, or is located farther from the second outer larger diameter portion 12a than the axis of the outer joint member 10 is). The direction in which the second outer larger diameter portion 12a is tilted with respect to the axis of the outer joint member 10 is opposite to that in which the first outer larger diameter portion 11a is tilted with respect to the axis of the outer joint member 10. The angle α2 formed by the second outer larger diameter portion 12a is larger than the angle α1 formed by the first outer larger diameter portion 11a, the angle α2 being a viewed angle for a track of the center of the ball 40, the track created by the ball 40 rolling on the second outer larger diameter portion 12a.

The arc radius Ra of the track of the center of the ball 40 rolling on the first outer larger diameter portion 11a is the same as the arc radius Re of the track of the center of the ball 40 rolling on the second outer larger diameter portion 12a.

The second outer smaller diameter portion 12b is formed closer to the inner side of the accommodating recess 10a than the second outer larger diameter portion 12a is in the second outer ball groove 12. The second outer smaller diameter portion 12b has an arc-shaped section in the axial direction. An arc radius Rf of the track of the center of the ball 40 rolling on the second outer smaller diameter portion 12b is smaller than the arc radius Re of the track of the center of the ball 40 rolling on the second outer larger diameter portion 12a. The arc radius Re is 1.1 to 7 times the arc radius Rf. The center Rf1 of the arc radius Rf of the track of the center of the ball 40 rolling on the second outer smaller diameter portion 12b is located closer to the opening side of the accommodating recess 10a than the joint center 99 is in the axial direction of the outer joint member 10. The center Rf1 of the arc radius Rf of the track of the center of the ball 40 rolling on the second outer smaller diameter portion 12b is located closer to the second outer smaller diameter portion 12b than the axis of the outer joint member 10 is in the radial direction of the outer joint member 10 (that is, the center Rf1 is located on the same side of the axis of the outer joint member 10 as the second outer smaller diameter portion 12b). The inside diameter of the second outer smaller diameter portion 12b gradually decreases closer to the inner side (bottom side) of the accommodating recess 10a.

The first inner ball groove 31 will be described below with reference to FIG. 7. In FIG. 7, an alternate long and short dashed line B represents the axis of the inner joint member 30, and a long dashed double-short dashed line represents the track of the center of the ball 40 rolling in the first inner ball groove 31. As shown in FIG. 7, the first inner ball groove 31 is formed by a first inner smaller diameter portion 31b, a first inner larger diameter portion 31a, and an inner tapered portion 31c which are continuously formed in this order from the opening side toward the inner side (bottom side) of the accommodating recess 10a.

The first inner smaller diameter portion 31b has an arc-shaped section in the axial direction. The center Rh1 of an arc radius Rh of the track of the center of the ball 40 rolling on the first inner smaller diameter portion 31b is located closer to the opening side of the accommodating recess 10a than the joint center 99 is in the axial direction of the inner joint member 30. The center Rh1 of the arc radius Rh of the track of the center of the ball 40 rolling on the first inner smaller diameter portion 31b is located closer to the first inner smaller diameter portion 31b than the axis of the inner joint member 30 is in the radial direction of the inner joint member 30 (that is, the center Rh1 is located on the same side of the axis of the inner joint member 30 as the first inner smaller diameter portion 31b).

The first inner larger diameter portion 31a has an arc-shaped section in the axial direction. The center Rg1 of an arc radius Rg of the track of the center of the ball 40 rolling on the first inner larger diameter portion 31a is located closer to the opening side of the accommodating recess 10a than the joint center 99 is in the axial direction of the inner joint member 30. The outside diameter of the first inner larger diameter portion 31a thus gradually decreases toward the inner side (bottom side) of the accommodating recess 10a. The center Rg1 of the arc radius Rg of the track of the center of the ball 40 rolling on the first inner larger diameter portion 31a is located beyond the axis of the inner joint member 30 in the radial direction of the inner joint member 30, as viewed from the first inner larger diameter portion 31a (that is, the center Rg1 is located on the opposite side of the axis of the inner joint member 30 from the first inner larger diameter portion 31a, or is located farther from the first inner larger diameter portion 31a than the axis of the inner joint member 30 is). The arc radius Rg of the track of the center of the ball 40 rolling on the first inner larger diameter portion 31a is larger than the arc radius Rh of the track of the center of the ball 40 rolling on the first inner smaller diameter portion 31b. The arc radius Rg is 1.1 to 7 times the arc radius Rh.

The angle β1 formed by the first inner larger diameter portion 31a is an viewed angle for a track of the center of the ball 40, the track created by the ball 40 rolling on the first inner larger diameter portion 31a in the case where the joint angle is a normal angle. The angle β1 is 6° to 8°. In the present embodiment, the angle β1 is 8°. The reason why the angle β1 is 6° to 8° is similar to the above reason why the angle α1 formed by the first outer larger diameter portion 11a is 6° to 8°.

The inner tapered portion 31c is formed closer to the inner side of the accommodating recess 10a than the first inner larger diameter portion 31a is in the first inner ball groove 31. The inner tapered portion 31c has such a tapered shape that its outside diameter gradually decreases closer to the inner side (bottom side) of the accommodating recess 10a. In the present embodiment, the angle θi formed by the inner tapered portion 31c and the axis of the inner joint member 30 in the axial direction of the inner tapered portion 31c is constant.

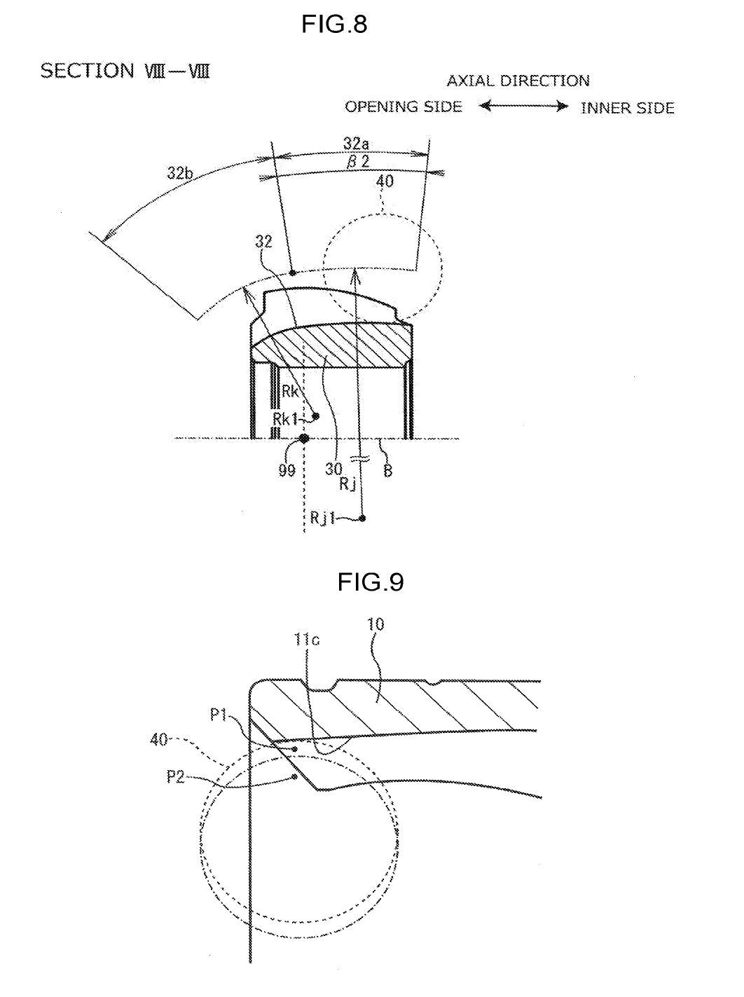

The second inner ball groove 32 will be described below with reference to FIG. 8. In FIG. 8, an alternate long and short dashed line B represents the axis of the inner joint member 30, and a long dashed double-short dashed line represents the track of the center of the ball 40 rolling in the second inner ball groove 32. As shown in FIG. 8, the second inner ball groove 32 is formed by a second inner smaller diameter portion 32b and a second inner larger diameter portion 32a which are continuously formed in this order from the opening side toward the inner side (bottom side) of the accommodating recess 10a. The angle β2 formed by the second inner larger diameter portion 32a is larger than the angle β1 formed by the first inner larger diameter portion 31a, the angle β2 being a viewed angle for a track of the center of the ball 40, the track created by the ball 40 rolling on the second inner larger diameter portion 32a.

The second inner smaller diameter portion 32b has an arc-shaped section in the axial direction. The center Rk1 of an arc radius Rk of the track of the center of the ball 40 rolling on the second inner smaller diameter portion 32b is located closer to the inner side (bottom side) of the accommodating recess 10a than the joint center 99 is in the axial direction of the inner joint member 30. The center Rk1 of the arc radius Rk of the track of the center of the ball 40 rolling on the second inner smaller diameter portion 32b is located closer to the second inner smaller diameter portion 32b than the axis of the inner joint member 30 is in the radial direction of the inner joint member 30.

The second inner larger diameter portion 32a has an arc-shaped section in the axial direction. The center Rj1 of an arc radius Rj of the track of the center of the ball 40 rolling on the second inner larger diameter portion 32a is located closer to the inner side (bottom side) of the accommodating recess 10a than the joint center 99 is in the axial direction of the inner joint member 30. The outside diameter of the second inner larger diameter portion 32a thus gradually increases toward the inner side (bottom side) of the accommodating recess 10a. The center Rj1 of the arc radius Rj of the track of the center of the ball 40 rolling on the second inner larger diameter portion 32a is located beyond the axis of the inner joint member 30 in the radial direction of the inner joint member 30, as viewed from the second inner larger diameter portion 32a. The arc radius Rj of the track of the center of the ball 40 rolling on the second inner larger diameter portion 32a is larger than the arc radius Rk of the track of the center of the ball 40 rolling on the second inner smaller diameter portion 32b. The arc radius Rj is 1.1 to 7 times the arc radius Rk. The arc radius Rg of the track of the center of the ball 40 rolling on the first inner larger diameter portion 31a is the same as the radius Rj.

Operation of the CV joint will be described below. In the case where the vehicle travels straight and the joint angle is a normal angle, each ball 40 located between the first outer ball groove 11 and the first inner ball groove 31 is held between the first outer larger diameter portion 11a and the first inner larger diameter portion 31a and rolls therebetween. The inside diameter of the first outer larger diameter portion 11a decreases toward the opening side of the accommodating recess 10a. The outside diameter of the first inner larger diameter portion 31a increases toward the opening side of the accommodating recess 10a. Each ball 40 held between the first outer larger diameter portion 11a and the first inner larger diameter portion 31a and rolling therebetween is therefore subjected to a first moving force toward the inner side of the accommodating recess 10a.

In the case were the vehicle travels straight and the joint angle is a normal angle, each ball 40 located between the second outer ball groove 12 and the second inner ball groove 32 is held between the second outer larger diameter portion 12a and the second inner larger diameter portion 32a and rolls therebetween. The inside diameter of the second outer larger diameter portion 12a increases toward the opening side of the accommodating recess 10a. The outside diameter of the second inner larger diameter portion 32a decreases toward the opening side of the accommodating recess 10a. Each ball 40 held between the second outer larger diameter portion 12a and the second inner larger diameter portion 32a and rolling therebetween is therefore subjected to a second moving force toward the opening side of the accommodating recess 10a. Since the first moving force and the second moving force act in the opposite directions, these forces cancel each other out, which reduces an axial moving force that is applied to the cage 50 in contact with the balls 40.

In the case where the joint angle is larger than a normal angle, each ball 40 located between the first outer ball groove 11 and the first inner ball groove 31 is held between the outer tapered portion 11c and the inner tapered portion 31c and rolls therebetween, or is held between the first outer smaller diameter portion 11b and the first inner smaller diameter portion 31b and rolls therebetween. In the case where the joint angle is larger than a normal angle, each ball 40 located between the second outer ball groove 12 and the second inner ball groove 32 is held between the second outer larger diameter portion 12a and the second inner larger diameter portion 32a and rolls therebetween, or is held between the second outer smaller diameter portion 12b and the second inner smaller diameter portion 32b and rolls therebetween.

When the ball 40 is held between the outer tapered portion 11c and the inner tapered portion 31c and rolls therebetween, each of the balls 40 adjacent to this ball 40 is held between the second outer larger diameter portion 12a and the second inner larger diameter portion 32a and rolls therebetween. The inside diameter of the outer tapered portion 11c decreases toward the opening side of the accommodating recess 10a. The outside diameter of the inner tapered portion 31c increases toward the opening side of the accommodating recess 10a. The ball 40 held between the outer tapered portion 11c and the inner tapered portion 31c and rolling therebetween is therefore subjected to the first moving force toward the inner side of the accommodating recess 10a. As described above, each ball 40 held between the second outer larger diameter portion 12a and the second inner larger diameter portion 32a and rolling therebetween is subjected to the second moving force toward the opening side of the accommodating recess 10a. Since the first moving force and the second moving force act in the opposite directions, these forces cancel each other out, which reduces the axial moving force that is applied to the cage 50 in contact with the balls 40.

When the ball 40 is held between the first outer smaller diameter portion 11b and the first inner smaller diameter portion 31b and rolls therebetween, each of the balls 40 adjacent to this ball 40 is held between the second outer smaller diameter portion 12b and the second inner smaller diameter portion 32b and rolls therebetween. The inside diameter of a part of the first outer smaller diameter portion 11b which is located near its connection portion with the first outer larger diameter portion 11a increases toward the inner side of the accommodating recess 10a. The outside diameter of a part of the first inner smaller diameter portion 31b which is located near its connection portion with the first inner larger diameter portion 31a increases toward the opening side of the accommodating recess 10a. Accordingly, in the case where the ball 40 is located on the part of the first outer smaller diameter portion 11b which is located near its connection portion with the first outer larger diameter portion 11a, or on the part of the first inner smaller diameter portion 31b which is located near its connection portion with the first inner larger diameter portion 31a, the ball 40 held between the first outer smaller diameter portion 11b and the first inner smaller diameter portion 31b and rolling therebetween is subjected to the first moving force toward the inner side of the accommodating recess 10a. The inside diameter of the second outer smaller diameter portion 12b decreases toward the inner side of the accommodating recess 10a. The outside diameter of the second inner smaller diameter portion 32b decreases toward the opening side of the accommodating recess 10a. Each ball 40 held between the second outer smaller diameter portion 12b and the second inner smaller diameter portion 32b and rolling therebetween is therefore subjected to the second moving force toward the opening side of the accommodating recess 10a. In the case where the ball 40 is located on the part of the first inner smaller diameter portion 31b which is located near its connection portion with the first inner larger diameter portion 31a, the first moving force and the second moving force act in the opposite directions. These forces thus cancel each other out, which reduces the axial moving force that is applied to the cage 50 in contact with the balls 40.

As can be seen from the above description, the CV joint 100 according to the present embodiment includes: the outer joint member 10 that has the accommodating recess 10a and that has the first outer ball grooves 11 and the second outer ball grooves 12 formed in its inner peripheral surface; the inner joint member 30 that is placed in the accommodating recess 10a and that can be angled with respect to the outer joint member 10 with the joint center 99 serving as a rotation center; the balls 40 each rolling between the first outer ball groove 11 or the second outer ball groove 12 and the inner joint member 30 to transmit torque; and the cage 50 that is placed between the inner peripheral surface of the outer joint member 10 and the outer peripheral surface of the inner joint member 30 to hold the balls 40. The first outer ball groove 11 has the first outer larger diameter portion 11a. The center Ra1 of the arc radius Ra of the track of the center of the ball 40 rolling on the first outer larger diameter portion 11a is located beyond the axis of the outer joint member 10 in the radial direction of the outer joint member 10, as viewed from the first outer larger diameter portion 11a. The center Ra1 of the arc radius Ra of the track of the center of the ball 40 rolling on the first outer larger diameter portion 11a is located closer to the inner side of the accommodating recess 10a than the joint center 99 is in the axial direction of the outer joint member 10. The second outer ball groove 12 has the second outer larger diameter portion 12a. The center Re1 of the arc radius Re of the track of the center of the ball 40 rolling on the second outer larger diameter portion 12a is located beyond the axis of the outer joint member 10 in the radial direction of the outer joint member 10, as viewed from the second outer larger diameter portion 12a. The center Re1 of the arc radius Re of the track of the center of the ball 40 rolling on the second outer larger diameter portion 12a is located closer to the opening side of the accommodating recess 10a than the joint center 99 is in the axial direction of the outer joint member 10. The first inner ball groove 31 has the first inner larger diameter portion 31a. The center Rg1 of the arc radius Rg of the track of the center of the ball 40 rolling on the first inner larger diameter portion 31a is located beyond the axis of the inner joint member 30 in the radial direction of the inner joint member 30, as viewed from the first inner larger diameter portion 31a. The center Rg1 of the arc radius Rg of the track of the center of the ball 40 rolling on the first inner larger diameter portion 31a is located closer to the opening side of the accommodating recess 10a than the joint center 99 is in the axial direction of the inner joint member 30. The second inner ball groove 32 has the second inner larger diameter portion 32a. The center Rj1 of the arc radius Rj of the track of the center of the ball 40 rolling on the second inner larger diameter portion 32a is located beyond the axis of the inner joint member 30 in the radial direction of the inner joint member 30, as viewed from the second inner larger diameter portion 32a. The center Rj1 of the arc radius Rj of the track of the center of the ball 40 rolling on the second inner larger diameter portion 32a is located closer to the inner side of the accommodating recess 10a than the joint center 99 is in the axial direction of the inner joint member 30.

The center Ra1 of the arc radius Ra of the track of the center of the ball 40 rolling on the first outer larger diameter portion 11a and the center Re1 of the arc radius Re of the track of the center of the ball 40 rolling on the second outer larger diameter portion 12a are thus located on different sides with respect to the joint center 99 in the axial direction of the outer joint member 10. The center Rg1 of the arc radius Rg of the track of the center of the ball 40 rolling on the first inner larger diameter portion 31a and the center Rj1 of the arc radius Rj of the track of the center of the ball 40 rolling on the second inner larger diameter portion 32a are also located on different sides with respect to the joint center 99 in the axial direction of the inner joint member 30. The moving forces that are applied to the balls 40 adjacent to each other thus cancel each other out. As described above, each ball 40 held between the first outer larger diameter portion 11a and the first inner larger diameter portion 31a and rolling therebetween is subjected to the first moving force toward the inner side (bottom side) of the accommodating recess 10a, and each ball 40 held between the second outer larger diameter portion 12a and the second inner larger diameter portion 32a and rolling therebetween is subjected to the second moving force toward the opening side of the accommodating recess 10a. Since the first moving force and the second moving force thus act in the opposite directions, these forces cancel each other out, which reduces the axial moving force that is applied to the cage 50 in contact with the balls 40. This reduces a frictional force that is generated between the cage 50 and the outer and inner joint members 10, 30 as the cage 50 is pressed by the outer joint member 10 and the inner joint member 30, whereby mechanical loss of the CV joint 100 is reduced.

Since formation and quality control of the first and second outer ball grooves 11, 12 are easier than S-shaped ball grooves, the outer joint member 10 can be manufactured without increasing cost. The CV joint 100 can thus be manufactured without increasing cost. The CV joint 100 can thus be provided which can reduce mechanical loss without increasing cost.

The first outer ball grooves 11 and the second outer ball grooves 12 are formed alternately in the circumferential direction of the outer joint member 10. The balls 40 adjacent to the ball 40 subjected to the first moving force are therefore subjected to the second moving force. The first moving force and the second moving force are thus generated at the positions adjacent to each other and cancel each other out. This restrains generation of the force in the rotational direction of the cage 50 by the balls 40 and thus reduces the frictional force that is generated between the cage 50 and the outer and inner joint members 10, 30, whereby mechanical loss of the CV joint 100 is reduced.

The maximum joint angle depends on the angle at which the shaft 20 contacts the opening of the accommodating recess 10a of the outer joint member 10. In the present embodiment, the center Ra1 of the arc radius Ra of the track of the center of the ball 40 rolling on the first outer larger diameter portion 11a is located beyond the axis of the outer joint member 10 in the radial direction of the outer joint member 10, as viewed from the first outer larger diameter portion 11a. The first outer ball groove 11 thus has a larger inside diameter on the opening side of the accommodating recess 10a as compared to the case where the center Ra1 is located on the axis of the outer joint member 10 or is located closer to the first outer larger diameter portion 11a than the axis of the outer joint member 10 is. Accordingly, the joint angle, namely the angle between the axis of the outer joint member 10 and the axis of the inner joint member 30, can further be increased.

The center Re1 of the arc radius Re of the track of the center of the ball 40 rolling on the second outer larger diameter portion 12a is located beyond the axis of the outer joint member 10 in the radial direction of the outer joint member 10, as viewed from the second outer larger diameter portion 12a. The arc radius Ra of the track of the center of the ball 40 rolling on the first outer larger diameter portion 11a is therefore not significantly different from (in the present embodiment, is the same as) the arc radius Re of the track of the center of the ball 40 rolling on the second outer larger diameter portion 12a. The first moving force is thus not significantly different from (in the present embodiment, is the same as) the second moving force, whereby the force that is applied from the balls 40 to the cage 50 can be reduced.

The arc radius Ra of the track of the center of the ball 40 rolling on the first outer larger diameter portion 11a is the same as the arc radius Re of the track of the center of the ball 40 rolling on the second outer larger diameter portion 12a. The shape of the first outer larger diameter portion 11a is therefore symmetrical with that of the second outer larger diameter portion 12a in the axial direction of the outer joint member 10 with respect to the joint center 99. The arc radius Rg of the track of the center of the ball 40 rolling on the first inner larger diameter portion 31a is the same as the arc radius Rj of the track of the center of the ball 40 rolling on the second inner larger diameter portion 32a. The shape of the first inner larger diameter portion 31a is therefore symmetrical with that of the second inner larger diameter portion 32a in the axial direction of the inner joint member 30 with respect to the joint center 99. Accordingly, the first moving force is the same as the second moving force, and the first and second moving forces completely cancel each other out. This further reduces the axial moving force that is applied to the cage 50 in contact with the balls 40, and thus further reduces the frictional force that is generated between the cage 50 and the outer and inner joint members 10, 30, whereby mechanical loss of the CV joint 100 is further reduced.

The first outer ball groove 11 has the outer tapered portion 11c located closer to the opening side of the accommodating recess 10a than the first outer larger diameter portion 11a is. The outer tapered portion 11c has such a tapered shape that its inside diameter gradually decreases toward the opening side of the accommodating recess 10a. The first inner ball groove 31 has the inner tapered portion 31c located closer to the inner side of the accommodating recess 10a than the first inner larger diameter portion 31a is. The inner tapered portion 31c has such a tapered shape that its inside diameter gradually decreases toward the inner side of the accommodating recess 10a. The first outer ball groove 11 therefore has a larger inside diameter on the opening side of the accommodating recess 10a as compared to the case where the first outer ball groove 11 is formed to have an arc shape in a portion corresponding to the outer tapered portion 11c. Accordingly, the joint angle, namely the angle between the axis of the outer joint member 10 and the axis of the inner joint member 30, can further be increased.

The first outer ball groove 11 has the first outer smaller diameter portion 11b located closer to the inner side (bottom side) of the accommodating recess 10a than the first outer larger diameter portion 11a is. The arc radius Rb of the track of the center of the ball 40 rolling on the first outer smaller diameter portion 11b is smaller than the arc radius Ra of the track of the center of the ball 40 rolling on the first outer larger diameter portion 11a. The second outer ball groove 12 has the second outer smaller diameter portion 12b located closer to the inner side of the accommodating recess 10a than the second outer larger diameter portion 12a is. The arc radius Rf of the track of the center of the ball 40 rolling on the second outer smaller diameter portion 12b is smaller than the arc radius Re of the track of the center of the ball 40 rolling on the second outer larger diameter portion 12a. The axial dimension of the outer joint member 10 can therefore be reduced as compared to the case where the first outer larger diameter portion 11a and the second outer larger diameter portion 12a are formed to extend to a position closer the inner side of the accommodating recess 10a. The axial dimension of the CV joint 100 can thus be reduced.

As shown in FIGS. 3, 4A, and 4B, the contact angle θ between the outer tapered portion 11c and the ball 40 in a section in the radial direction of the outer joint member 10 gradually decreases from the inner side toward the opening side of the accommodating recess 10a. As shown in FIG. 9, when the ball 40 is located in the opening of the accommodating recess 10a, the ball 40 therefore contacts the outer tapered portion 11c at contact points P1 located at the bottom of the outer tapered portion 11c, and the ball 40 is located on the bottom of the outer tapered portion 11c. The ball 40 is thus prevented from coming off from the outer tapered portion 11c. The ball 40 comes off from the outer tapered portion 11c when it moves away from the bottom of the outer tapered portion 11c (as shown by an alternate long and short dashed line in FIG. 9). The maximum joint angle depends on such an angle that the ball 40 does not come off from the first outer ball groove 11. In the present embodiment, as described above, the contact angle θ between the outer tapered portion 11c and the ball 40 in a section of the outer tapered portion 11c in the direction perpendicular to the track of the center of the ball 40 gradually decreases from the inner side toward the opening side of the accommodating recess 10a. This prevents the ball 40 from coming off from the first outer ball groove 11 (outer tapered portion 11c) and can further increase the maximum joint angle.

The angle α1 (FIG. 3) formed by the first outer larger diameter portion 11a in the axial direction of the outer joint member 10 is an angle by which the ball 40 rolls on the first outer larger diameter portion 11a in the case where the joint angle is a normal angle. The angle β1 formed by the first inner larger diameter portion 31a in the axial direction of the inner joint member 30 is an angle by which the ball 40 rolls on the first inner larger diameter portion 31a in the case where the joint angle is a normal angle. Accordingly, when the vehicle travels straight, namely in most traveling states of the vehicle, the ball 40 is held between the first outer larger diameter portion 11a and the first inner larger diameter portion 31a and rolls therebetween. This reduces the frictional force that is generated between the cage 50 and the outer and inner joint members 10, 30, and thus reduces mechanical loss of the CV joint 100.

The number of first outer ball grooves 11 is the same as that of second outer ball grooves 12. Accordingly, the number of first moving forces that are generated is the same as that of second moving forces, which further reduces the axial moving force that is applied to the cage 50 in contact with the balls 40.

Another embodiment will be described below. In the above embodiment, the arc radius Ra of the track of the center of the ball 40 rolling on the first outer larger diameter portion 11a is the same as the arc radius Re of the track of the center of the ball 40 rolling on the second outer larger diameter portion 12a. However, the arc radius Ra may be different from the arc radius Re. In such an embodiment as well, the first and second moving forces cancel each other out, which reduces the axial moving force that is applied to the cage 50 in contact with the balls 40, and thus reduces the frictional force generated between the cage 50 and the outer and inner joint members 10, 30. Mechanical loss of the CV joint 100 is thus reduced.

The contact angle θ between the second outer larger diameter portion 12a and the ball 40 in a section of the second outer larger diameter portion 12a in a direction perpendicular to the track of the center of the ball 40 (a section in the radial direction of the outer joint member 10) may gradually decrease from the inner side toward the opening side of the accommodating recess 10a. In such an embodiment, the ball 40 can be prevented from coming off from the second outer larger diameter portion 12a and the maximum joint angle can further be increased.

The contact angle θ between the outer tapered portion 11c and the ball 40 in the section in the radial direction of the outer joint member 10 may be constant from the inner side toward the opening side of the accommodating recess 10a.

The outer joint member 10 described above has the shape of a bottomed cylinder. However, the outer joint member 10 may have the shape of a cylinder. In this case, spline grooves may be formed in the inner peripheral surface on the inner side of the accommodating recess 10a, and a shaft (first torque transmission member) having spline grooves formed in its outer periphery may be spline-fitted in the spline grooves.

What is claimed is:

1. A constant-velocity joint, comprising:
an outer joint member that has an accommodating recess and that has first outer ball grooves and second outer ball grooves formed in its inner peripheral surface;
an inner joint member that has first inner ball grooves and second inner ball grooves formed in its outer peripheral surface, that is placed in the accommodating recess, and that can be angled with respect to the outer joint member with a joint center serving as a rotation center;
balls each rolls between corresponding one of the first outer ball grooves and corresponding one of the first inner ball grooves or between corresponding one of the second outer ball grooves and corresponding one of the second inner ball grooves to transmit torque; and
a cage that is placed between the inner peripheral surface of the outer joint member and the outer peripheral surface of the inner joint member to hold the balls, wherein
the first outer ball grooves each have a first outer larger diameter portion,
a center of an arc radius of a track of a center of the ball rolling on the first outer larger diameter portion is located beyond an axis of the outer joint member in a radial direction of the outer joint member, as viewed from the first outer larger diameter portion,
the center of the arc radius of the track of the center of the ball rolling on the first outer larger diameter portion is located closer to an inner side of the accommodating recess than the joint center is in an axial direction of the outer joint member,
the second outer ball grooves each have a second outer larger diameter portion,
a center of an arc radius of a track of the center of the ball rolling on the second outer larger diameter portion is located beyond the axis of the outer joint member in the radial direction of the outer joint member, as viewed from the second outer larger diameter portion,
the center of the arc radius of the track of the center of the ball rolling on the second outer larger diameter portion is located closer to an opening side of the accommodating recess than the joint center is in the axial direction of the outer joint member,
the first inner ball grooves each have a first inner larger diameter portion,
a center of an arc radius of a track of the center of the ball rolling on the first inner larger diameter portion is located beyond an axis of the inner joint member in a radial direction of the inner joint member, as viewed from the first inner larger diameter portion,
the center of the arc radius of the track of the center of the ball rolling on the first inner larger diameter portion is located closer to the opening side of the accommodating recess than the joint center is in an axial direction of the inner joint member,
the second inner ball grooves each have a second inner larger diameter portion,
a center of an arc radius of a track of the center of the ball rolling on the second inner larger diameter portion is located beyond the axis of the inner joint member in the radial direction of the inner joint member, as viewed from the second inner larger diameter portion, and
the center of the arc radius of the track of the center of the ball rolling on the second inner larger diameter portion is located closer to the inner side of the accommodating recess than the joint center is in the axial direction of the inner joint member.

2. The constant-velocity joint according to claim 1, wherein
the first outer ball grooves and the second outer ball grooves are formed alternately in a circumferential direction of the outer joint member.

3. The constant-velocity joint according to claim 1, wherein
the arc radius of the track of the center of the ball rolling on the first outer larger diameter portion is the same as that of the track of the center of the ball rolling on the second outer larger diameter portion, and
the arc radius of the track of the center of the ball rolling on the first inner larger diameter portion is the same as that of the track of the center of the ball rolling on the second inner larger diameter portion.

4. The constant-velocity joint according to claim 1, wherein
the first outer ball grooves each have an outer tapered portion that is formed closer to the opening side of the accommodating recess than the first outer larger diameter portion is, and that has such a tapered shape that its inside diameter gradually decreases toward the opening side of the accommodating recess, and
the first inner ball grooves each have an inner tapered portion that is formed closer to the inner side of the accommodating recess than the first inner larger diameter portion is, and that has such a tapered shape that its inside diameter gradually decreases toward the inner side of the accommodating recess.

5. The constant-velocity joint according to claim 1, wherein
the first outer ball grooves each have a first outer smaller diameter portion formed closer to the inner side of the accommodating recess than the first outer larger diameter portion is,
an arc radius of a track of the center of the ball rolling on the first outer smaller diameter portion is smaller than that of the track of the center of the ball rolling on the first outer larger diameter portion,
the second outer ball grooves each have a second outer smaller diameter portion formed closer to the inner side of the accommodating recess than the second outer larger diameter portion is, and
an arc radius of a track of the center of the ball rolling on the second outer smaller diameter portion is smaller than that of the track of the center of the ball rolling on the second outer larger diameter portion.

6. The constant-velocity joint according to claim 1, wherein
a contact angle between at least one of the outer tapered portion and the second outer larger diameter portion and the ball in a section in the radial direction of the outer joint member gradually decreases from the inner side toward the opening side of the accommodating recess.

7. The constant-velocity joint according to claim 1, wherein
an angle formed by the first outer larger diameter portion in the axial direction of the outer joint member is an viewed angle for a track of the center of the ball, the track created by the ball rolling on the first outer larger diameter portion in the case where an angle formed by the axis of the inner joint member and the axis of the outer joint member is a normal angle that is an angle when a vehicle travels straight, and
an angle formed by the first inner larger diameter portion in the axial direction of the inner joint member is an viewed angle for a track of the center of the ball, the track created by the ball rolling on the first inner larger diameter portion in the case where the angle formed by the axis of the inner joint member and the axis of the outer joint member is the normal angle.

8. The constant-velocity joint according to claim 1, wherein
the number of first outer ball grooves is the same as that of second outer ball grooves.
